(19) United States
(12) Patent Application Publication
(10) Pub. No.: US 2025/0229451 A1
(43) Pub. Date: Jul. 17, 2025

(54) BUCKING STATION APPARATUS

(71) Applicant: Stephen T. Allen, Big Rock, IL (US)

(72) Inventor: Stephen T. Allen, Big Rock, IL (US)

(21) Appl. No.: 18/413,888

(22) Filed: Jan. 16, 2024

(51) Int. Cl. B27B 31/00

(52) U.S. Cl. CPC B27B 31/00

(57) ABSTRACT

Bucking station apparatus having first and second bucking station support, each includes lower longitudinally extending base bar having opening for receiving respective fork of vehicle, a device for securing the bucking station support to the vehicle, the lower longitudinally extending base bar includes a front end and a back end which define a first or overall length, a front upright is secured at generally right angle to the lower longitudinally extending base bar at approximately the front end, a back upright is secured at generally right angle to the lower longitudinally extending base bar spaced apart from the front upright by load depth distance, the back upright is spaced apart from the back end by a clearance distance for spacing the cutting operation from the vehicle, the heights of the uprights define a load height distance, the first and second bucking station supports are spaced apart from one another.

### FIELD OF THE INVENTION

The present invention relates to bucking stations and, in particular, to a bucking station apparatus for attachment to a plurality of forks.

### BACKGROUND OF THE INVENTION

The prior art includes boards or lumber which are cut on the ground or placed in a stationary rack to be cut. The prior art also includes U.S. Pat. No. 3,812,951 is directed to a bucking and log handling apparatus. The apparatus includes a bucking station where log stems are cut to at least one desirable length. Positioned transversely from the bucking stations are at least two axially spaced holding stations with means associated with one holding station to move the log segment axially. The holding stations provide temporary support for the log segments until they are called for downstream at which point the holding function is removed and the log segments fall into the outflow conveyor system. U.S. Pat. No. 4,468,993 is directed to a bucking station for small logs.

### SUMMARY OF THE INVENTION

In one embodiment, the present invention provides a bucking station apparatus having a first and second bucking station support, each bucking station support includes a lower longitudinally extending base bar having a pocket or opening for receiving a respective fork of a vehicle, a device for securing the bucking station support to the vehicle, the lower longitudinally extending base bar includes a front end and a back end, the front end and back end define a first or overall length, a front upright is secured at generally a right angle to the lower longitudinally extending base bar at approximately the front end, a back upright is secured at generally a right angle to the lower longitudinally extending base bar spaced apart from the front upright by a load depth distance, the back upright is spaced apart from the back end by a clearance distance for spacing the cutting operation from the vehicle, the heights of the uprights define a load height distance, whereby the first and second bucking station supports are spaced apart from one another by the distance between the pair of spaced apart forks.

### BRIEF DESCRIPTION OF THE DRAWINGS

FIG. 1 is a perspective view of the bucking station apparatus in accordance with one embodiment of the present invention.

FIG. 2 is a side view of one of the two bucking station supports shown in FIG. 1.

FIG. 3 is a top view of the bucking station support shown in FIG. 2.

FIG. 4 is a front view of the bucking station support shown in FIG. 2.

FIG. 5 is a perspective view representing a prior art vehicle with a pair of forks wherein the bucking station apparatus of the present invention has been installed.

FIG. 6 is an end view of the back end of a lower longitudinally extending base bar shown in FIG. 2.

FIG. 7 is a perspective view of a trailer style hitch pin and clip.

### DETAILED DESCRIPTION OF THE INVENTION

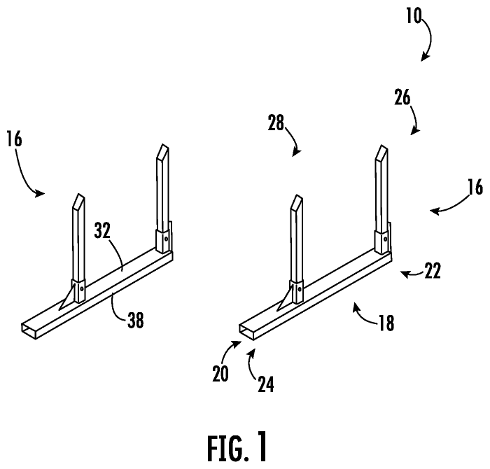

FIG. 1 is a perspective view of the bucking station apparatus 10 in accordance with one embodiment of the present invention.

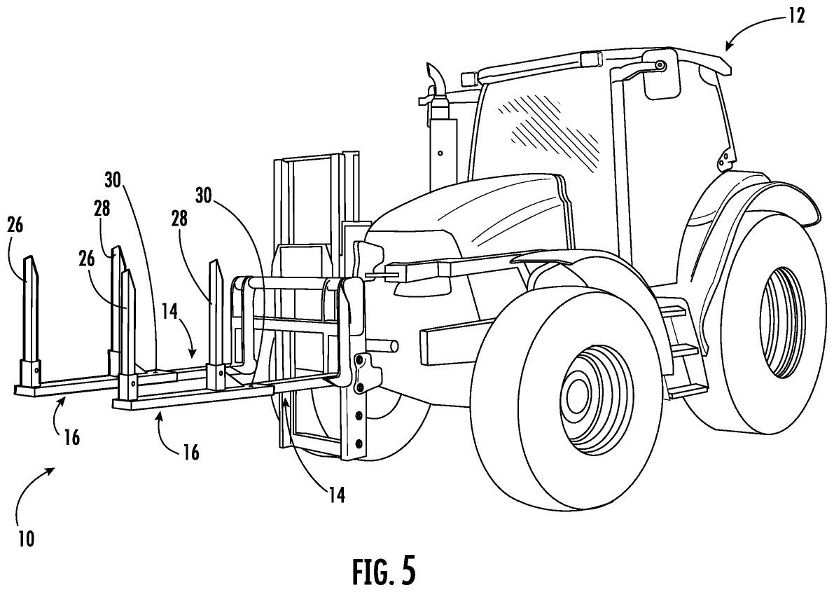

FIG. 5 is a perspective view representing a prior art vehicle 12 with a pair of forks 14 wherein the bucking station apparatus 10 of the present invention has been installed.

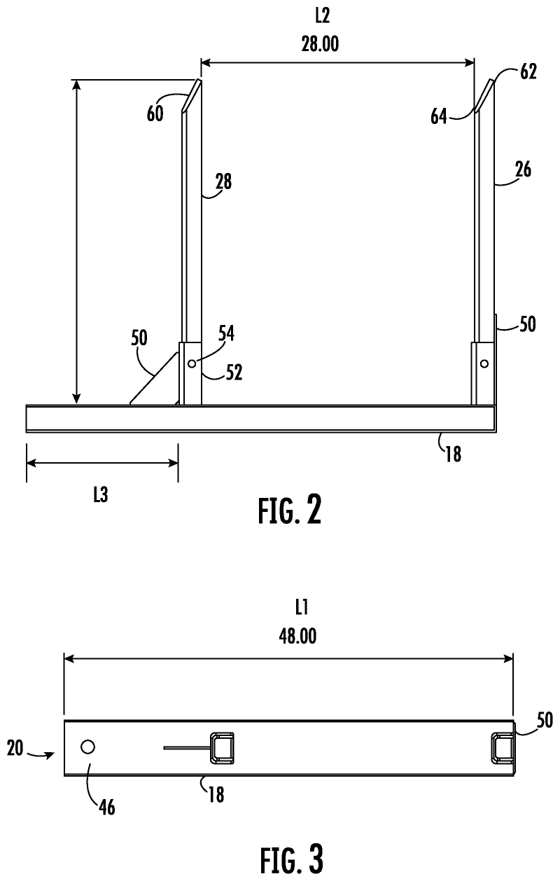

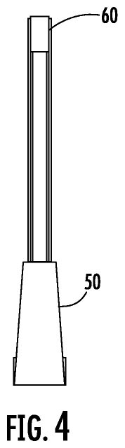

As shown in FIGS. 1-4, the bucking station apparatus 10 includes a plurality of bucking station supports 16. In one embodiment, the bucking station supports 16 are generally identical.

In the embodiment of FIG. 1, each bucking station support 16 includes a lower longitudinally extending base bar 18 having a pocket or opening 20. The lower longitudinally extending base bar 18 includes a front end 22 and a back end 24, the front end 22 and back end 24 define a first or overall length L1. A front upright 26 is secured at generally a right angle to the lower longitudinally extending base bar 18 at approximately the front end 22. A back upright 28 is secured at generally a right angle to the lower longitudinally extending base bar 18 spaced apart from the front upright 26 by a load depth distance L2. The back upright 28 is spaced apart from the back end 24 by a clearance distance L3 for spacing the cutting operation from the vehicle 12. The heights of the uprights define a load height distance L4. The load depth distance L2 may be in the range of 16 to 26 inches, so as to accommodate chainsaw bars from about 20 to 28 inches. The clearance distance L3 may be in the range of 10 to 24 inches, whereby there is clearance provided between the end of the chainsaw (not shown) and the vehicle 12 during cutting operation.

The lower longitudinally extending base bar 18 is a rectangular tube and in one embodiment the width is 5 inches and the height is 2.5 inches. Other dimensions are anticipated as long as the pocket or opening 20 will receive the fork 14. For example, the rectangular tube may have a width in the range of 3 to 5 inches and a height in the range of 1 to 3 inches. Other embodiments may not provide a rectangular tube. For example, a flat bar or round tube (not shown) may be provided. For a flat bar, a pocket or opening 20 might be formed by a right angle flange (not shown) located at the back end 24.

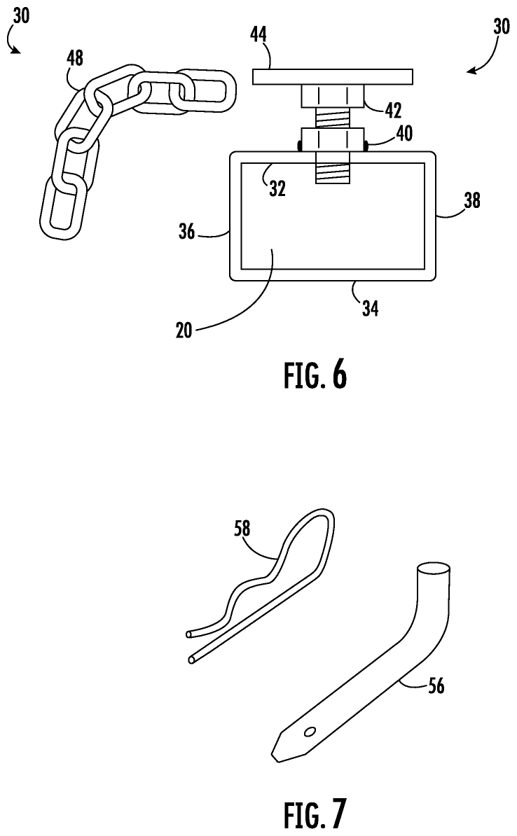

The bucking station supports 16 may include a device 30 for temporarily securing the bucking station support 16 to the vehicle 12. Each of the rectangular tubes includes a top, bottom, left, and right side wall 32, 34, 36, 38. In one embodiment, the securing device includes a threaded opening 40 formed through one of the walls of the rectangular tube. A threaded bolt 42 is threadingly received by the threaded opening, and the threaded bolt may include a handle 44 for ease of operation, whereby after the respective rectangular tube is slid over the respective fork, the threaded bolt is adjust to secure or clamp the bucking station support 16 to the vehicle 12. In one embodiment, the threaded opening is formed through the top wall 32. The threaded opening 40 may be formed by welding or otherwise securing a threaded nut 40 over an opening 46 extending through the wall. See FIG. 6 for additional details of the device 30.

In another embodiment, the securing device may include a chain or cable 48 having a first end and a second end. One end is secured to the bucking station support 16 via welding, or bolt and nut, or other means. After the respective rectangular tube is slid over the respective fork, the other end of the chain or cable is secured to the vehicle 12. Other embodiments of the securing device are also anticipated.

Each upright may include at least one gusset plate 50 secured to the lower longitudinally extending base bar 18 to reinforce the respective upright. Preferably the gusset plates are not located within the space between the front upright 26 and back upright 28, so as to not interfere with the loading of wood or lumber there between. The gusset plates may be secured via bolts, rivets, welding, or the like.

As shown in FIGS. 1-4, each upright includes a short sleeve 52 secured to the lower longitudinally extending base bar 18, such as via welding or other means. The upright is removably received by the sleeve. The upright and sleeve include a pair of holes 54 which are aligned with the upright received by the sleeve. A bolt or trailer hitch style pin 56 and clip 58 (see FIG. 7) are removably installed through the holes 54 to secure the upright to the base bar 18. Preferably the pins are not located within the space between the front upright 26 and back upright 28, so as to not interfere with the loading of wood or lumber there between.

In the embodiment shown, the uprights have a top end 60, wherein the top ends are slanted downwards towards the back end 24, with the front side 62 of the top end 60 higher than the back side 64 of the top end. With this arrangement, with the forks arranged with the front uprights parallel to the ground, the uprights more easily slide under a load to be picked up.

It will be appreciated that with the bucking station apparatus 10 of the present invention has been installed on the pair of forks 14 of the vehicle 12, the first and second bucking station supports are spaced apart from one another by the distance between the pair of spaced apart forks. In some systems, the distance between the forks may be adjusted. Such an option allows more flexibility in adjusting the apparatus for cutting the desired lengths.

In operation, the vehicle 12 is operated so that the forks extend in a generally horizontal direction. Each bucking station support 16 is slid over the respective fork. Next, the bolt is secured to clamp the bucking station support 16 to the respective fork of the vehicle 12. Alternatively, or in addition, the other end of a cable of chain may be used to secure to the bucking station support 16 to the vehicle 12. The vehicle 12 is again be operated but this time so that the forks extend downwardly so that the front uprights extend in a generally horizontal direction. The vehicle 12 and forks are manipulated so that the front uprights are slid under a load of wood or lumber. Thus, a stack of lumber may be loaded on the bucking station apparatus 10 without hand loading. The vehicle 12 and forks are manipulated so as to lift and move the load as desired. A chainsaw is used to cut the wood into the desired lengths. The chainsaw may be used to cut wood between the two bucking station supports 16 or on either lateral side.

The present invention may be used with fork blades or tubular shaped forks, as well as other styled forks. All of these are referred to herein as forks. As there is no structure between the bucking station supports 16, the chainsaw may cut all the way through the load. Also, the user may space the boards laterally to adjust the cutting lengths as desired.

1. A bucking station apparatus for attachment to a vehicle having a pair of spaced apart forks, the apparatus comprising:
a first and second bucking station support;
each bucking station support includes
a lower longitudinally extending base bar having a pocket or opening for receiving a respective fork of a vehicle,
a device for securing the bucking station support to the vehicle,
the lower longitudinally extending base bar includes a front end and a back end, the front end and back end define a first or overall length,
a front upright is secured at generally a right angle to the lower longitudinally extending base bar at approximately the front end,
a back upright is secured at generally a right angle to the lower longitudinally extending base bar spaced apart from the front upright by a load depth distance, the back upright is spaced apart from the back end by a clearance distance for spacing the cutting operation from the vehicle,
the heights of the uprights define a load height distance,
whereby the first and second bucking station supports are spaced apart from one another by the distance between the pair of spaced apart forks.

2. The bucking station apparatus of claim 1, wherein each of the lower longitudinally extending base bar is a rectangular tube.

3. The bucking station apparatus of claim 2, wherein each of the rectangular tube has a width in the range of 3 to 5 inches and a height in the range of 1 to 3 inches, whereby the rectangular tube may be received by the respective fork.

4. The bucking station apparatus of claim 2, wherein each of the rectangular tube includes a top, bottom, left, and right side wall, and each of the device for securing the bucking station support to the vehicle includes a threaded opening formed through one of the walls of the rectangular tube, a threaded bolt is threadingly received by the threaded opening, and the threaded bolt may include a handle for ease of operation, whereby after the respective rectangular tube is received by the respective fork, the threaded bolt is adjust to secure the bucking station support to the vehicle.

5. The bucking station apparatus of claim 4, wherein the threaded opening is formed through the top wall.

6. The bucking station apparatus of claim 1, wherein each upright includes at least one gusset plate secured to the lower longitudinally extending base bar to reinforce the respective upright, and preferably the gusset plates are not located within the space between the front upright and back upright.

7. The bucking station apparatus of claim 1, wherein each upright includes a sleeve secured to the lower longitudinally extending base bar, and the upright is removably received by the sleeve, the upright and sleeve include a pair of holes which are aligned with the upright received by the sleeve, a pin is removably installed through the holes to secure the upright to the base bar, and preferably the pins are not located within the space between the front upright and back upright.

8. The bucking station apparatus of claim 1, wherein the load depth distance is in the range of 16 to 26 inches, so as to accommodate chainsaw bars from about 20 to 28 inches.

9. The bucking station apparatus of claim 1, wherein the clearance distance is in the range of 10 to 24 inches, whereby there is clearance distance is provided between the end of the chainsaw and the vehicle during cutting operation.

10. The bucking station apparatus of claim 1, wherein the uprights have a top end, wherein the top ends are slanted, with the front side of the top end higher than the back side of the top end, whereby the uprights more easily slide under a load to be picked up.

11. A bucking station comprising a vehicle having a pair of spaced apart forks, and the buckingstation apparatus of claim 1 removably secured to the spaced apart forks.
